(19) United States
(12) Patent Application Publication
(10) Pub. No.: US 2025/0199139 A1
(43) Pub. Date: Jun. 19, 2025

(54) SIGNAL PROCESSING METHOD AND DEVICE FOR PHOTO DETECTOR

(71) Applicant: SOLIDVUE, INC., Gyeonggi-do (KR)

(72) Inventors: Min Kyung KIM, Gyeonggi-do (KR); Hyeong Seok SEO, Gyeonggi-do (KR); Jae Hyuk CHOI, Seoul (KR)

(73) Assignee: SOLIDVUE, INC., Gyeonggi-do (KR)

(21) Appl. No.: 18/393,792

(22) Filed: Dec. 22, 2023

(30) Foreign Application Priority Data
Dec. 15, 2023 (KR) 10-2023-0182735

(51) Int. Cl. G01S 7/4865

(52) U.S. Cl. CPC G01S 7/4865

(57) ABSTRACT

A signal processing method and device for a light receiving device are disclosed. The signal processing device cumulatively records a number of receptions of an echo laser up to a predefined threshold in N time slots (N is a natural number of 2 or more), selects a plurality of priority time slots in an order in which the number of receptions reaches the threshold, cumulatively records the number of receptions for the plurality of priority time slots, omits records of a number of receptions for remaining time slots, and determines a reception time slot of the echo laser based on an accumulated number of receptions of the plurality of priority time slots.

### CROSS-REFERENCE TO RELATED APPLICATION

This application is based on and claims priority under 35 U.S.C. § 119 to Korean Patent Application No. 10-2023-0182735, filed on Dec. 15, 2023, in the Korean Intellectual Property Office, the disclosure of which is incorporated by reference herein in its entirety.

### BACKGROUND

### 1. Field

The disclosure relates to a method of and device for processing signals for a light receiving device, and more particularly, to a method of and device for processing signals for a time-to-digital converter (TDC) of a light receiving device used to measure a time of flight (TOF) in a light detection and ranging (LiDAR) sensor or image sensor.

### 2. Description of the Related Art

FIG. 1 is a diagram showing an example of a conventional LiDAR. A light detection and ranging (LiDAR) 100 outputs a laser signal in the form of a pulse wave using a light emitting device such as a vertical cavity surface emitting laser (VCSEL)/edge emitting laser diode (EELD). The light receiving device 120 detects a laser signal (hereinafter referred to as echo laser) reflected from the object 130 and returned to the light receiving device 120. An example of the light receiving device 120 is a single photon avalanche diode (SPAD). The LIDAR 100 determines the distance to the object 130 by measuring the time (i.e., TOF) in which the laser signal output from the light emitting device is reflected and returned to the object 130.

In order to increase the resolution (angular resolution) of the LiDAR 100, the resolution of pixels that detect light in the light receiving device 120 must be increased. FIG. 2 is a diagram showing an example of an arrangement structure of a light receiving device and a time-to-digital converter (TDC) in a LiDAR. Referring to FIG. 2, a TDC element 210 is placed in each column of a pixel array 200. Therefore, to increase the pixel resolution, it is necessary to reduce not only the pixel size, but also the size of the TDC 210.

### SUMMARY

Provided is a signal processing method and device that may increase the resolution of a light receiving device by reducing a size of histogram memory used during signal processing for TOF measurement.

Additional aspects will be set forth in part in the description which follows and, in part, will be apparent from the description, or may be learned by practice of the presented embodiments of the disclosure.

According to an aspect of the disclosure, a method of processing signals for a light receiving device includes cumulatively recording a number of receptions of an echo laser up to a predefined threshold in N time slots (N is a natural number of 2 or more); selecting a plurality of priority time slots in an order in which the number of receptions reaches the threshold; cumulatively recording a number of receptions for the plurality of priority time slots and omitting records of a number of receptions for remaining time slots; and determining a reception time slot of the echo laser based on an accumulated number of receptions of the plurality of priority time slots.

According to another aspect of the disclosure, a signal processing device for a receiving device includes a first memory that cumulatively stores a number of echo laser receptions up to a predefined threshold in a plurality of time slots; a priority determination unit configured to refer to the first memory and determine at least one of M (M is a natural number of 2 or more) priority time slots in which a number of receptions reaches the threshold; a second memory that cumulatively stores the number of receptions for at least one priority time slot identified by the priority determination unit; and a signal output unit configured to determine and output a reception time slot of an echo laser based on the accumulated number of receptions of at least one priority time slot stored in the second memory.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram showing an example of a conventional LiDAR;

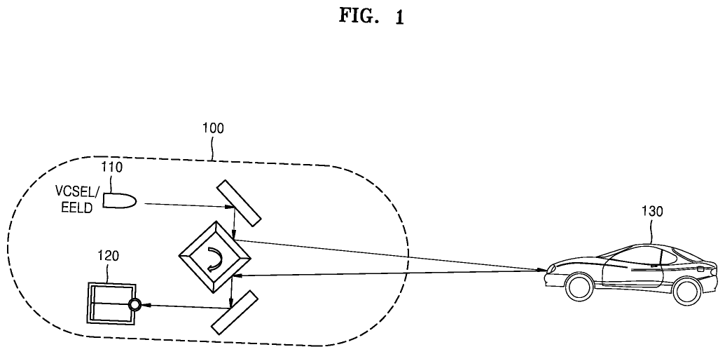

FIG. 2 is a diagram showing an example of an arrangement structure of a light receiving device and a time-to-digital converter (TDC) in a LIDAR;

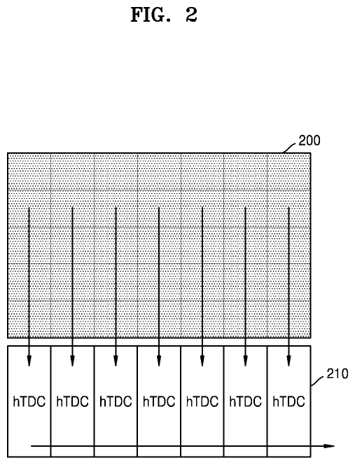

FIG. 3 is a diagram showing an example of histogram memory used for TOF measurement;

FIG. 4 is a diagram showing another example of histogram memory used for TOF measurement;

FIG. 5 is a flowchart showing an example of a signal processing method used by a light receiving device according to an embodiment of the present invention;

FIG. 6 is a diagram showing an example of histogram memory for the signal processing method of FIG. 5;

FIG. 7 is a diagram illustrating an example of a histogram memory for a first-time slot identification process according to an embodiment of the present invention;

FIG. 8 is a diagram showing an example of histogram memory for identifying a second-time slot according to an embodiment of the present invention;

FIG. 9 is a diagram illustrating another example of histogram memory for a second-time slot identification process according to an embodiment of the present invention, and

FIG. 10 is a diagram showing an example of a light receiving device including a signal processing device according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a signal processing method and device for a light receiving device according to an embodiment of the present invention are described in detail with reference to the attached drawings.

The signal processing device of this embodiment may be used not only in a light detection and ranging (LiDAR) sensor or an image sensor, but also in various places where time of flight (TOF) measurement is required, and the field of use of the signal processing device of this embodiment is not limited to a specific sensor. However, for convenience of explanation, the following description is focus on the case where the signal processing device is used as a time-to-digital converter (TDC) of the light receiving element of the LiDAR sensor.

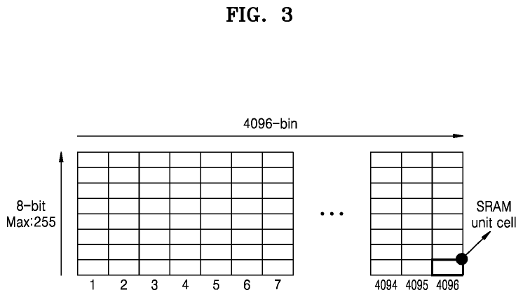

FIG. 3 is a diagram showing an example of histogram memory used for TOF measurement.

Referring to FIG. 3, a signal processing device divides a predefined measurement range time into a plurality of time slots in order to measure an elapsed time required for a signal (for example, a laser pulse) output from a light-emitting device to be reflected by an object and reach a light-receiving device. This embodiment presents a case where the measurement range time t is divided into 2¹² (=4,096) time slots to implement a 12-bit TOF. The measurement range time may be preset to various values depending on the embodiment.

When the first pulse is output from the light emitting device, the signal processing device records in which of the 4,096 time slots the first pulse was detected. When the second pulse is output from the light emitting device, the signal processing device records in which of the 4,096 time slots the second pulse was detected. In this way, the signal processing device sequentially records in which time slot each of the plurality of pulses continuously output from the light emitting device was detected. The LiDAR sensor outputs a plurality of pulses in succession and then determines a TOF based on the number of signal detections in each time slot.

The signal processing device can cumulatively store the number of echo laser receptions for each time slot in the histogram memory in order to determine the number of signal detections in each time slot. The histogram memory of this embodiment includes 4,096 bits corresponding to each time slot on the horizontal axis and 8 bits for accumulating the number of receptions of each echo laser on the vertical axis. Because the range of numbers that may be expressed in 8 bits is 0 to 255 (i.e. 2⁸), the histogram memory may store a total of 256 echo laser reception times. In the histogram memory, the bit string (i.e., vertical bit string) corresponding to each time slot is called a bin. The histogram memory of this embodiment includes a total of 4,096 bins. This embodiment uses a histogram memory with a total of 32,769 (=8*4,096) bits to cumulatively store the number of receptions of 256 echo lasers.

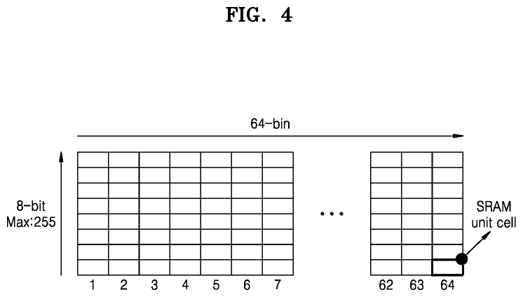

FIG. 4 is a diagram showing another example of histogram memory used for TOF measurement.

Referring to FIG. 4, the histogram memory includes 64 bits corresponding to 64 time slots on the horizontal axis and 8 bits on the vertical axis to store the cumulative number of receptions of 256 echo lasers.

The signal processing device divides the measurement range time into 64 time slots and cumulatively stores the number of echo laser receptions in each time slot. For example, the signal processing device accumulates and stores the number of receptions of the echo laser in each time slot in each bin of the histogram memory.

The signal processing device identifies the bin (i.e., time slot) with a maximum accumulated count based on the accumulated number of receptions of the echo laser recorded in the histogram memory. For example, when the accumulated count of bin number 6 is the maximum, the signal processing device determines the time slot corresponding to bin number 6 as an additional search time slot. Afterwards, the signal processing device divides the additional search time slot (for example, the time slot of bin 6) into 64 detailed time slots and then allocates each detailed time slot to each bin of the histogram memory. The signal processing device cumulatively stores the number of echo laser receptions in each bin of the histogram memory corresponding to the detailed time slot.

In this embodiment, the measurement range time is divided into 64 time slots to first determine the reception time slot of the echo laser, and the firstly identified reception time slot (i.e., additional search time slot) is further divided into 64 time slots to secondarily determine the reception time slot of the echo laser. The first and second identification processes are performed using the same histogram memory.

This embodiment has a total time resolution of 64*64=4,096 through the first and second identification processes, so this embodiment has the same time resolution as the 12-bit-TOF of FIG. 3. Because this embodiment uses a total of 512 bits (=64*8) of histogram memory to determine the reception time slot of the echo laser, histogram memory usage may be reduced by approximately 98.43% compared to FIG. 3. In other words, changing the 1-step method of FIG. 3 to the 2-step method of FIG. 4 may significantly reduce the amount of histogram memory used for TOF measurement. This embodiment proposes a 6-bit/6-bit 2-step method to implement 12-bit TOF, but this is only an example. The resolution of the first step and the second step, such as 7 bits/5 bits, may be varied depending on the embodiment.

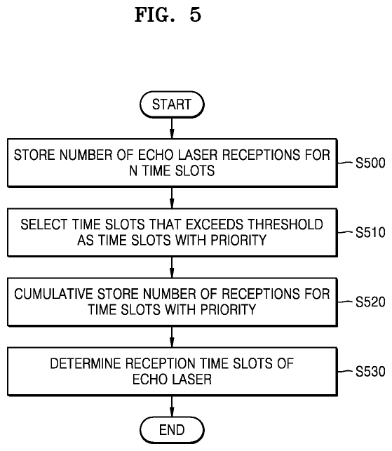

FIG. 4 shows that the amount of histogram memory usage is significantly reduced compared to FIG. 3. However, in order to make the size of the signal processing device smaller, it is necessary to further reduce the amount of histogram memory used. Methods that may further reduce the histogram memory usage of FIG. 4 are discussed in FIG. 5 and the following drawings.

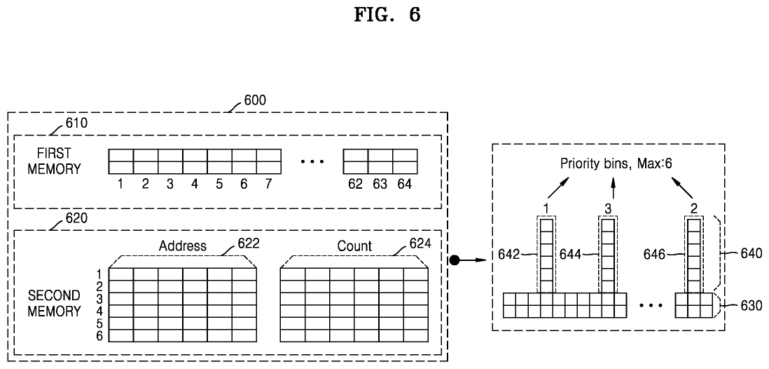

FIG. 5 is a flowchart showing an example of a signal processing method used by a light receiving device according to an embodiment of the present invention, and FIG. 6 is a diagram showing an example of histogram memory for the signal processing method of FIG. 5.

Referring to FIGS. 5 and 6 together, in operation S500, the signal processing device cumulatively records the number of receptions of the echo laser up to a predefined threshold in N time slots (N is a natural number of 2 or more). The minimum size of the histogram memory 600 required to accumulate and store the number of receptions for N time slots up to the threshold is the product of the number of bits required to express the threshold and the number of time slots N. For example, when the threshold is 4, which may be expressed in 2 bits and there are 64 time slots, the histogram memory 600 requires 2*64 bits like the first memory 610 of FIG. 6. FIG. 6 shows a first memory structure where N=64 and the cumulative number of receptions for each bin may be counted up to 4 times (i.e., threshold=4), but this is only an example. The number of time slots N and the threshold value may vary depending on the embodiment, and the number of bits of the first memory 610 may vary accordingly. However, for convenience of explanation, the following description is based on the first memory 610 of FIG. 6.

In operation S510, the signal processing device selects a plurality of priority time slots in the order in which the number of receptions reaches the threshold. For example, in the first memory 610, bin number 9 may be the first to reach an accumulation count of 4, which is the threshold, and bin number 4 may be the second time to reach an accumulation count of 4. In this case, the signal processing device first selects the time slots corresponding to bin numbers 4 and 9 as the priority time slots. The example of FIG. 6 presents a configuration for selecting up to six priority time slots, but the number of priority time slots may be modified in various ways depending on the embodiment.

Increasing the number of priority time slots lowers area efficiency but improves noise immunity. In the example of FIG. 6, among the 64 bins, the bin that reaches the threshold value of 4 first is selected as the priority time slot, but when the number of priority time slots is small, noise may fill up the priority time slots, causing a problem of not being able to accurately determine the reception time of the echo laser. Therefore, the number of priority time slots may be appropriately predetermined depending on the embodiment, considering area efficiency and noise immunity.

In operation S520, when the selection of a predefined number of priority time slots is completed, the signal processing device cumulatively records the number of receptions for a plurality of priority time slots and omits the records of the number of receptions for the remaining time slots. For example, when the time slots of bin number 4 and bin number 9 are selected as priority time slots through the first memory 610, even if the echo laser is detected in the time slots other than bin numbers 4 and 9, the signal processing device does not record the detection of the echo laser in the time slots. That is, because the echo laser detected in the time slots other than the priority time slots is noise, the detected echo laser is not counted.

In one embodiment, the signal processing device may store the cumulative number of receptions of the echo laser for a priority time slot in the second memory 620. The first memory 610 and the second memory 620 may be logically separate memories or physically separate memories. The second memory 620 may include an address area 622 for storing address information and a count area 624 for storing the accumulated number of receptions. The address of the first memory 610 (i.e., a bin address of the first memory) corresponding to the priority time slot is stored in the address area 622, and the cumulative number of echo laser receptions for the priority time slot is stored in the count area 622.

In this embodiment, rather than accumulating the number of echo laser receptions for the entire time slots, the number of echo laser receptions is accumulated only for a certain number of priority time slots, thereby reducing the amount of histogram memory usage. Conceptually, when bin number 4 (642), bin number 9 (644), and bin number 63 (646) are selected as priority time slots, the cumulative count is stored only for bin numbers 4, 8, and 63, and the cumulative count is not stored for the remaining time slots. That is, 2 bits of the first memory 610 are allocated to each of the general time slots (see reference number 630), and 6 bits of the count area 624 of the second memory 620 are additionally allocated to each of the priority time slots (see reference number 640).

The example of the second memory 620 in FIG. 6 is just an example to aid understanding. The structure of the second memory 620 for storing the cumulative number of echo laser receptions for the priority time slots may be modified in various ways depending on the embodiment. However, for convenience of explanation, the following description is based on the second memory 620 of FIG. 6.

In operation S530, the signal processing device determines the reception time slot of the echo laser based on the cumulative number of receptions of a plurality of priority time slots. For example, when the priority time slots identified based on the threshold are the time slots of bin number 4 and bin number 9 and the final cumulative number of receptions for the bin number 4 is the largest, the signal processing device outputs the time slot of bin number 4 as the reception time slot of the echo laser.

The process of identifying a priority time slot using the first memory 610 is a coarse operation of identifying candidate time slots with a high possibility of receiving the echo laser, so there is no need to determine much about the number of reception times of the echo laser. However, because the process of determining the accumulated number of receptions in the priority time slot using the second memory 620 is a fine operation of determining the exact reception time slot of the echo laser, it is desirable to determine the number of receptions of the echo laser as many times as possible.

For example, in the example of FIG. 6, the signal processing device performs a process of identifying up to four echo laser receptions through the first memory 610 to determine the priority time slot and performs a process of identifying up to 2⁸ (=256) echo laser receptions for the priority time slot through the first memory 610 and the second memory 620. The first memory 610 includes 64*2 (=128) bits, and the second memory 620 include includes a total of 72 bits, which is ‘(maximum number of priority time slots=6)*((number of bits in address area=6)+(number of bits in count area=6))’. Therefore, the histogram memory 600 used in the embodiment of FIG. 6 has a total of 200 bits. Compared to the example of FIG. 4, the embodiment of FIG. 6 may reduce histogram memory usage by approximately 61%. Compared to the embodiment of FIG. 3, the embodiment of FIG. 6 may reduce histogram memory usage by approximately 99.39%.

In order to improve time resolution, the signal processing device may perform two step identification processes as shown in the example of FIG. 4. For example, the signal processing device divides the measurement range time into M time slots (M is a natural number of 2 or more) and then performs a first-time slot identification process from operations S500 to S530 in FIG. 5. Through the first-time slot identification process, at least one time slot in which the echo laser exists may be identified within the measurement range time.

Next, the signal processing device subdivides at least one time slot identified in the first-time slot identification process into K time slots (K is a natural number of 2 or more), then performs a second-time slot identification process of operations S500 to S530 in FIG. 5. In other words, the time slot identified in the first-time slot identification process is subdivided into K sub time slots, and then it is determined in which of the sub time slots the echo laser was received. When attempting to implement the 12-bit TOF of FIG. 4, both M of the first-time slot identification process and K of the second-time slot identification process may be set to 64. The values of M and K according to embodiments may be varied in various ways.

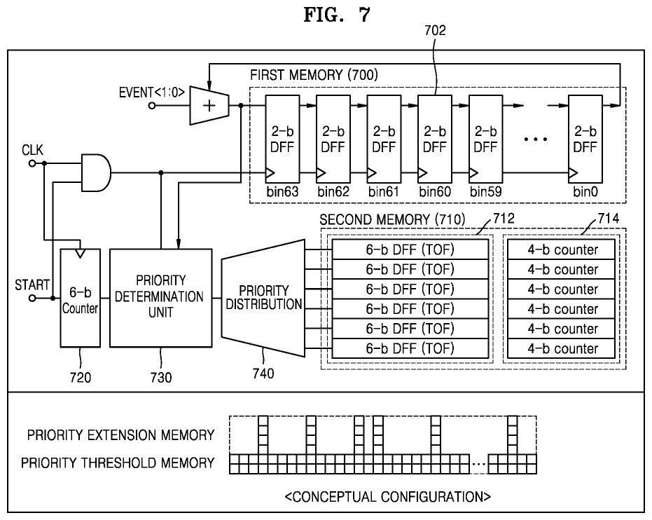

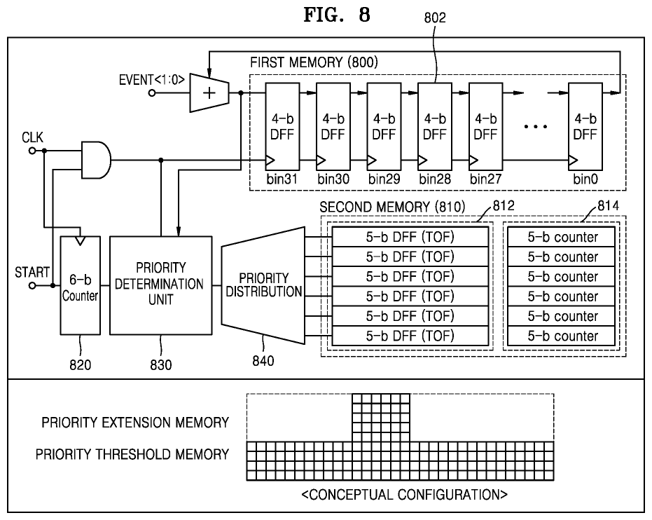

In another embodiment, the threshold values for identifying a priority time slot may be set differently in the first and second-time slot identification processes. The method of processing signals by setting different threshold values in the first and second-time slot identification processes without changing the overall usage of the histogram memory 600 is examined again in FIGS. 7 and 8.

FIG. 7 is a diagram illustrating an example of a histogram memory for a first-time slot identification process according to an embodiment of the present invention, and FIG. 8 is a diagram showing an example of histogram memory for identifying a second-time slot according to an embodiment of the present invention.

Referring to FIGS. 7 and 8 together, the histogram memory includes first memories 700 and 800 and second memories 710 and 810. The first memories 700 and 800 and the second memories 710 and 810 may be implemented with a plurality of data flip-flops (DFF). This embodiment is only an example, and the first memories 700 and 800 and the second memories 710 and 810 may be implemented with various devices other than DFF and are not limited to a specific example. However, for convenience of explanation, the following description is made assuming that the first memories 700 and 800 and the second memories 710 and 810 are implemented as DFFs.

When the first memories 700 and 800 include T DFFs, the first memories 700 and 800 allocate DFFs of [T/N] bits to each time slot in order to store the number of echo laser receptions for N time slots (N is a natural number of 2 or more). Because the size of the first memories 700 and 800 is ‘number of time slots (N)*number of bits for threshold’, increasing the threshold should reduce the number of time slots, and conversely, increasing the number of time slots should reduce the threshold.

In the example of FIG. 7, because the number of DFFs in the first memory 700 is 128 and the threshold is 4, which may be expressed in 2 bits, the number of time slots N is 64. In this case, the first memory 700 allocates a 2-bit DFF 702 to each time slot so that the cumulative number of echo laser receptions for each time slot is stored up to 4 times. In the example of FIG. 8, because the threshold is 16, which may be expressed in 4 bits, the number of time slots N is 32. In this case, the first memory 800 allocates a 4-bit DFF 802 to each time slot so that the cumulative number of echo laser receptions for each time slot is stored up to 16 times.

That is, by varying the number of DFFs 702 and 802 allocated to each time slot without changing the size of the first memories 700 and 800, the threshold indicating the maximum cumulative number of receptions in each time slot may be set differently.

When the number of DFFs 702 and 802 allocated to each time slot in the first memories 700 and 800 varies, the number of DFFs allocated to the address areas 712 and 812 and count areas 714 and 814 of the second memories 710 and 810 are changed. When M DFFs are provided in each priority time slot of the second memories 710 and 810 and N time slots exist in the first memories 700 and 800, the second memories 710 and 810 may allocate a b-bit DFF (b is [log₂N], that is, the number of bits required to express N time slots) to the address area and an (M−a) bit DFF to the count area.

In the example of FIG. 7, because there are 10 DFFs for each priority time slot in the second memory 710 and the total number of time slots N in the first memory 700 is 64, the second memory 710 may allocate 6 bits (that is, the number of bits required to represent 64 bin addresses of the first memory=6) to the address area 712 and the remaining 4 bits to the count area 714.

In the example of FIG. 8, because there are 10 DFFs for priority time slots and the total number of time slots N in the first memory 800 is 32, the second memory 810 may allocate 5 bits (i.e., the number of bits required to represent the 64 bin addresses of the first memory=6) to the address area 812 and the remaining 5 bits to the count area 814.

Because the first-time slot identification process in FIG. 7 is a coarse operation of dividing the measurement range time into 64 sections to determine the time slot in which the echo laser exists, the signal processing device sets a low threshold for identifying many priority time slots. On the other hand, in FIG. 8, after subdividing the time slot (i.e., measurement range time/64) identified in the first-time slot identification process, it is necessary to accurately determine which time slot the echo laser has reached, so in order to effectively remove noise, the threshold for identifying priority time slots may be made larger than the first-time slot identification process. In this embodiment, the threshold in FIG. 7 is 4, and the threshold in FIG. 8 is 16.

FIGS. 7 and 8 are just one example to explain how the memories should be reconfigured when the sizes of the first memories 700 and 800 and the second memories 710 and 810 are fixed and the threshold values are different, and the present invention is not limited to the examples in FIGS. 7 and 8.

In one embodiment, in the first-time slot identification process of FIG. 7, the signal processing device may select a plurality of candidate time slots from among a plurality of priority time slots. For example, in the first-time slot identification process, the two highest priority time slots may be identified as candidates for the reception time slot of the echo laser based on the cumulative number of receptions of the second memory 710 among the plurality of priority time slots. In this case, the second-time slot identification process may be performed using the method in FIG. 8 for each of the two candidate time slots identified in the first time slot identification process.

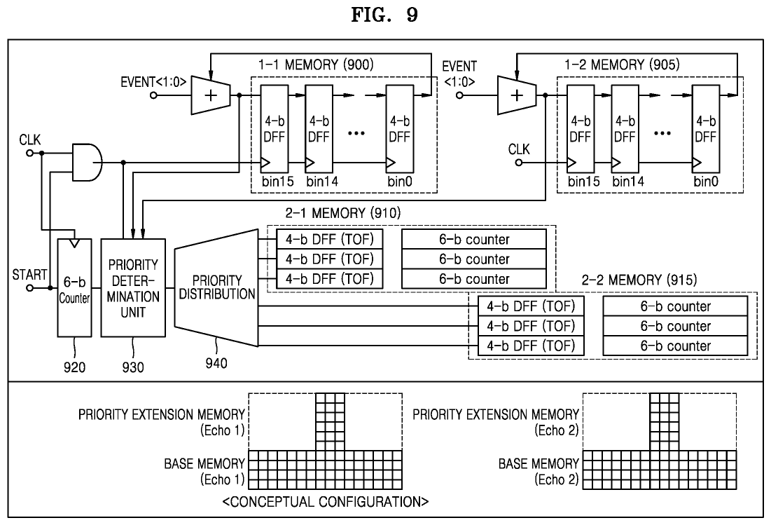

In another embodiment, when two or more time slots are selected as candidates for the reception time slot of the echo laser in the first-time slot identification process, the signal processing device may simultaneously perform the second-time slot identification process for a plurality of candidate time slots. An example of a histogram memory for this is shown in FIG. 9.

FIG. 9 is a diagram illustrating another example of histogram memory for a second-time slot identification process according to an embodiment of the present invention. FIG. 9 shows a case where two candidates for reception time slots of an echo laser are selected through the first-time slot identification process of FIG. 7. The candidate time slots selected in the first-time slot identification process are hereinafter referred to as the first analysis slot and the second analysis slot.

Referring to FIG. 9, the first memory 800 shown in FIG. 8 is divided into a 1-1 memory 900 and a 1-2 memory 905. The 1-1 memory 900 is a memory for the first analysis slot, and the 1-2 memory 905 is a memory for the second analysis slot. The number of DFTs in the 1-1 memory 900 is the same as the number of DFFs in the 1-2 memory 905.

In this embodiment, the threshold for identifying the priority time slot is 16 (i.e., 4 bits are required) as shown in FIG. 8, the 1-1 memory 900 allocates 4 bits of DFF to each of 16 time slots, and the 1-2 memory 905 allocates 4 bits of DFF to each of 16 time slots. That is, the first memory 800 of FIG. 8 is divided into two areas and used as a 1-1 memory 900 and a 1-2 memory 905.

The second memory 810 of FIG. 8 is divided into a plurality of memory areas depending on the number of analysis slots. For example, as shown in FIG. 8, when there are areas of 6 time priority slots in the second memory 810, the second memory 810 is divided into a 2-1 memory 910 and a 2-1 memory 915, each of which includes three priority time slots. The 2-1 memory 910 is used to determine the accumulated number of priority time slots for the first analysis slot, and the 2-2 memory 915 is used to determine the accumulated number of priority time slots for the second analysis slot.

Because the number of time slots (i.e., the number of bins) represented by the 1-1 memory 900 and 1-2 memory 905 is reduced compared to FIG. 8, the size of the address areas of the 2-1 memory 910 and the 2-2 memory 915 is also reduced. For example, because the number of bins in the 1-1 memory 900 and 1-2 memory 905 is 16, the size of the address areas of the 2-1 memory 910 and the 2-2 memory 915 is 4 bits, and the remaining 6 bits may be allocated to the count area.

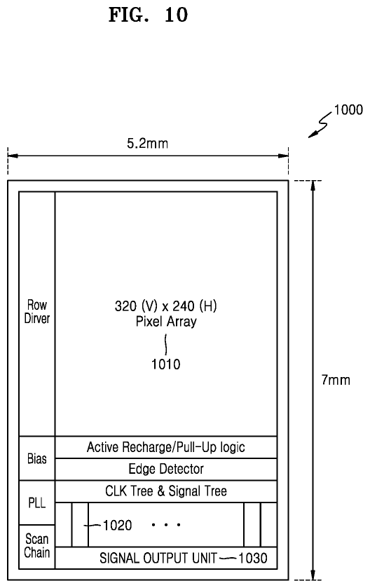

FIG. 10 is a diagram showing an example of a light receiving device including a signal processing device according to an embodiment of the present invention.

Referring to FIG. 10, a signal processing device 1020 for processing the signal detected by the pixel array 1010 of the light receiving device 1000 may be provided one for each row of the pixel array 1010. The signal processing device 1020 may be used as a TDC.

In one embodiment, the signal processing device may include a histogram memory including first memories 700, 800, 900, 905 and second memories 710, 810, 910, 915, priority determination units 730, 830, 930, and a signal output unit 1030, etc., as shown in the embodiments of FIGS. 7 to 9. In addition, the signal processing unit may include a 6-bit counter 720, 820, and 920, a distribution unit 740, 840, and 940, etc. The 6-bit counters 720, 820, and 920 that provide clock signals and the distribution units 740, 840, and 940 that store information about priority time slots in the second memories 710, 810, 910, and 915 may be modified in various ways depending on the embodiment. The logic circuit of each component of the signal processing device may be implemented as a semiconductor device on the same substrate as the pixel array 1010. Hereinafter, the description focuses on the configuration required to implement the signal processing device.

The first memories 700, 800, 900, and 905 accumulate and store the number of receptions of the echo laser up to a predefined threshold in a plurality of time slots.

The priority determination units 730, 830, and 930 refer to the first memories 700, 800, 900, and 905 to identify at least one of M (M is a natural number of 2 or more) priority time slots in which the number of receptions reaches the threshold.

The second memories 710, 810, 910, and 915 cumulatively store the number of receptions for at least one priority time slot identified by the priority determination unit. In one embodiment, the second memories 710, 810, 910, and 915 may cumulatively store the number of receptions mapped to the address information of the first memories 700, 800, 900, and 905 corresponding to each priority time slot.

The signal output unit 1030 determines the reception time slot of the echo laser based on the accumulated number of receptions of at least one priority time slot stored in the second memory 710, 810, 910, and 915.

The present invention may also be implemented as computer-readable program code on a computer-readable recording medium. Computer-readable recording media include all types of recording devices that store data that may be read by a computer system. Examples of computer-readable recording media include ROM, RAM, CD-ROM, magnetic tape, floppy disk, and optical data storage devices. In addition, computer-readable recording media may be distributed across networked computer systems so that computer-readable code may be stored and executed in a distributed manner.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

According to an embodiment of the present invention, the amount of histogram memory used for signal processing for TOF measurement may be reduced. Because histogram memory usage is small, a TDC may be implemented with a small memory size. In addition, the resolution of the light receiving device may be improved by reducing the size of the pixel and TDC of the light receiving device.

What is claimed is:

1. A method of processing signals for a light receiving device, the method comprising:
cumulatively recording a number of receptions of an echo laser up to a predefined threshold in N time slots (N is a natural number of 2 or more);
selecting a plurality of priority time slots in an order in which the number of receptions reaches the threshold;
cumulatively recording a number of receptions for the plurality of priority time slots and omitting records of a number of receptions for remaining time slots; and
determining a reception time slot of the echo laser based on an accumulated number of receptions of the plurality of priority time slots.

2. The method of claim 1, further comprising
a first-time slot identification process of dividing a measurement range time into M (M is a natural number greater than or equal to 2) time slots, and then performing from the cumulatively recording the number of receptions for the M time slots up to a threshold to the determining the reception time slot; and
a second-time slot identification process of subdividing at least one reception time slot identified in the first-time slot identification process into K (K is a natural number of 2 or more) time slots, and then performing from cumulatively recording a number of receptions for the K time slots up to a threshold to determining the reception time slot.

3. The method of claim 2, wherein the second-time slot identification process includes
generating a plurality of analysis slots by dividing each of a plurality of reception time slots identified in the first-time slot identification process into K time slots; and
further performing from the cumulatively recording the number of receptions up to a threshold to determining the reception time slot for each of the plurality of analysis slots.

4. The method of claim 1,
wherein the accumulating the number of receptions up to a threshold includes storing the number of receptions for each of the N time slots in a first memory, and
the cumulatively storing the number of receptions for the priority time slots includes storing each number of receptions for the plurality of priority time slots in a second memory.

5. The method of claim 2,
wherein, in the first-time slot identification process, the number of receptions in the time slot is stored in a first memory up to a first threshold,
in the second-time slot identification process, the number of receptions in the time slot is stored in the first memory up to a second threshold,
the number of time slots K in the second-time slot identification process is less than the number of time slots M in the first-time slot identification process, and
the second threshold is greater than the first threshold.

6. A signal processing device for a receiving device, the signal processing device comprising:
a first memory that cumulatively stores a number of echo laser receptions up to a predefined threshold in a plurality of time slots;
a priority determination unit configured to refer to the first memory and determine at least one of M (M is a natural number of 2 or more) priority time slots in which a number of receptions reaches the threshold;
a second memory that cumulatively stores the number of receptions for at least one priority time slot identified by the priority determination unit; and
a signal output unit configured to determine and output a reception time slot of an echo laser based on the accumulated number of receptions of at least one priority time slot stored in the second memory.

7. The signal processing device of claim 6,
wherein the first memory includes T data flip-flops, and
the first memory allocates a data flip-flop of [T/N] bits to each time slot to store the number of echo laser receptions for N (N is a natural number of 2 or more) time slots.

8. The signal processing device of claim 6, wherein the second memory cumulatively stores the number of receptions mapped to address information of the first memory corresponding to each priority time slot.

9. The signal processing device of claim 7,
wherein the second memory includes M data flip-flops allocated to each priority time slot, and
the second memory allocates a b-bit (b is [log₂N]) data filp-flop to an address area and allocates a b (M−a)-bit data flip-flop to a count area.

10. The signal processing device of claim 6, wherein the first memory is divided into a plurality of areas when there are a plurality of analysis slots divided into N (N is a natural number of 2 or more) time slots.
